(19) United States
(12) Patent Application Publication
(10) Pub. No.: US 2025/0209642 A1
(43) Pub. Date: Jun. 26, 2025

(54) METHOD AND SYSTEM FOR ANALYZING USER MOTION

(71) Applicant: MOAIS, INC., Seoul (KR)

(72) Inventor: Yong Geun LEE, Seoul (KR)

(73) Assignee: MOAIS, INC., Seoul (KR)

(21) Appl. No.: 18/670,853

(22) Filed: May 22, 2024

(30) Foreign Application Priority Data
Dec. 22, 2023 (KR) 10-2023-0190431

(51) Int. Cl. G06T 7/292; G06T 7/246

(52) U.S. Cl. CPC G06T 7/292; G06T 7/248

(57) ABSTRACT

According to one aspect of the present invention, there is provided a method for analyzing a user's motion, the method comprising the steps of: generating a motion data set for a motion of a user on the basis of at least one image of the motion of the user; determining a partial motion data set for a partial motion of the user by separating the motion data set by partial motions of the user; and determining a first relevance between the partial motion of the user and a reference partial motion by comparing the partial motion data set with a reference partial motion data set determined by separating a reference motion data set by reference partial motions.

### CROSS-REFERENCE TO RELATED APPLICATION

This application claims priority to Korean Patent Application No. 10-2023-0190431 filed on Dec. 22, 2023, the entire contents of which are herein incorporated by reference.

### FIELD OF THE INVENTION

The present invention relates to a method and system for analyzing a user's motion.

### BACKGROUND

In athletic disciplines such as taekwondo, taekkyon, wushu, diving, and golf, a user's motion may be separated into at least one partial motion. The user's motion in these disciplines may be evaluated by comparison with a reference motion (e.g., a preset form motion).

A conventional technique for analyzing a user's motion has been proposed in which an instructor acquires an image of the user's motion and determines whether the user has performed a motion that conforms to a reference motion on the basis of the acquired image. However, according to the conventional technique, there is a problem that whether the user has properly performed the motion is determined by the subjective judgment of the instructor. Further, the conventional technique has a problem that the instructor is required to personally evaluate the user's exercise motions, which is time-consuming and costly.

In this connection, the inventor(s) present a technique for supporting the precise analysis (or evaluation) of a user's motion by generating a motion data set for a motion of a user on the basis of at least one image of the motion of the user; determining a partial motion data set for a partial motion of the user by separating the motion data set by partial motions of the user; and determining a first relevance between the partial motion of the user and a reference partial motion by comparing the partial motion data set with a reference partial motion data set determined by separating a reference motion data set by reference partial motions.

### SUMMARY OF THE INVENTION

One object of the present invention is to solve all the above-described problems in prior art.

Another object of the invention is to generate a motion data set for a motion of a user on the basis of at least one image of the motion of the user, determine a partial motion data set for a partial motion of the user by separating the motion data set by partial motions of the user, and determine a first relevance between the partial motion of the user and a reference partial motion by comparing the partial motion data set with a reference partial motion data set determined by separating a reference motion data set by reference partial motions.

Yet another object of the invention is to compare a motion data set and a reference motion data set, thereby precisely determining a relevance (e.g., similarity) between a user's motion and a reference motion (e.g., a preset form motion).

Still another object of the invention is to generate motion analysis information with reference to at least one of a first relevance between a user's partial motion and a reference partial motion, and a second relevance between the user's overall motion and a reference overall motion, thereby specifically analyzing the user's motion in terms of the partial motion and the overall motion.

The representative configurations of the invention to achieve the above objects are described below.

According to one aspect of the invention, there is provided a method comprising the steps of: generating a motion data set for a motion of a user on the basis of at least one image of the motion of the user; determining a partial motion data set for a partial motion of the user by separating the data set by partial motions of the user; and determining a first relevance between the partial motion of the user and a reference partial motion by comparing the partial motion data set with a reference partial motion data set determined by separating a reference motion data set by reference partial motions.

According to another aspect of the invention, there is provided a system comprising: a data set generation unit configured to generate a motion data set for a motion of a user on the basis of at least one image of the motion of the user; a data set determination unit configured to determine a partial motion data set for a partial motion of the user by separating the motion data set by partial motions of the user; and a relevance determination unit configured to determine a first relevance between the partial motion of the user and a reference partial motion by comparing the partial motion data set with a reference partial motion data set determined by separating a reference motion data set by reference partial motions.

In addition, there are further provided other methods and systems to implement the invention, as well as non-transitory computer-readable recording media having stored thereon computer programs for executing the methods.

According to the invention, it is possible to generate a motion data set for a motion of a user on the basis of at least one image of the motion of the user, determine a partial motion data set for a partial motion of the user by separating the motion data set by partial motions of the user, and determine a first relevance between the partial motion of the user and a reference partial motion by comparing the partial motion data set with a reference partial motion data set determined by separating a reference motion data set by reference partial motions.

According to the invention, it is possible to compare a motion data set and a reference motion data set, thereby precisely determining a relevance (e.g., similarity) between a user's motion and a reference motion (e.g., a preset form motion).

According to the invention, it is possible to generate motion analysis information with reference to at least one of a first relevance between a user's partial motion and a reference partial motion, and a second relevance between the user's overall motion and a reference overall motion, thereby specifically analyzing the user's motion in terms of the partial motion and the overall motion.

### BRIEF DESCRIPTION OF THE DRAWINGS

FIG. 1 schematically shows the configuration of an entire system according to one embodiment of the invention.

FIG. 2 specifically shows the internal configuration of a motion analysis system according to one embodiment of the invention.

FIG. 3 illustratively shows a situation in which a motion data set according to one embodiment of the invention is generated.

FIGS. 4A to 4D illustratively show a situation in which a motion data set according to one embodiment of the invention is generated.

FIGS. 5A to 5D illustratively show a situation in which a motion data set according to one embodiment of the invention is generated.

### DETAILED DESCRIPTION

In the following detailed description of the present invention, references are made to the accompanying drawings that show, by way of illustration, specific embodiments in which the invention may be practiced. These embodiments are described in sufficient detail to enable those skilled in the art to practice the invention. It is to be understood that the various embodiments of the invention, although different from each other, are not necessarily mutually exclusive. For example, specific shapes, structures, and characteristics described herein may be implemented as modified from one embodiment to another without departing from the spirit and scope of the invention. Furthermore, it shall be understood that the positions or arrangements of individual elements within each embodiment may also be modified without departing from the spirit and scope of the invention. Therefore, the following detailed description is not to be taken in a limiting sense, and the scope of the invention is to be taken as encompassing the scope of the appended claims and all equivalents thereof. In the drawings, like reference numerals refer to the same or similar elements throughout the several views.

Hereinafter, various preferred embodiments of the present invention will be described in detail with reference to the accompanying drawings to enable those skilled in the art to easily implement the invention.

### Configuration of the Entire System

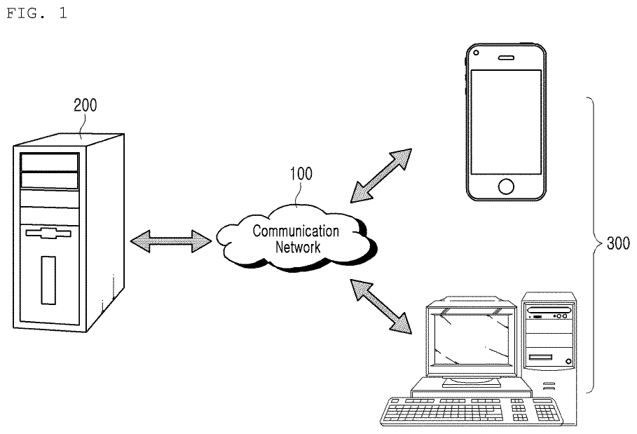

FIG. 1 schematically shows the configuration of the entire system according to one embodiment of the invention.

As shown in FIG. 1, the entire system according to one embodiment of the invention may comprise a communication network 100, a motion analysis system 200, and a device 300. First, the communication network 100 according to one embodiment of the invention may be implemented regardless of communication modality such as wired and wireless communications, and may be constructed from a variety of communication networks such as local area networks (LANs), metropolitan area networks (MANs), and wide area networks (WANs). Preferably, the communication network 100 described herein may be the Internet or the World Wide Web (WWW). However, the communication network 100 is not necessarily limited thereto, and may at least partially include known wired/wireless data communication networks, known telephone networks, or known wired/wireless television communication networks.

For example, the communication network 100 may be a wireless data communication network, at least a part of which may be implemented with a conventional communication scheme such as WiFi communication, WiFi-Direct communication, Long Term Evolution (LTE) communication, 5G communication, Bluetooth communication (including Bluetooth Low Energy (BLE) communication), infrared communication, and ultrasonic communication. As another example, the communication network may be an optical communication network, at least a part of which may be implemented with a conventional communication scheme such as LiFi (Light Fidelity).

Next, the motion analysis system 200 according to one embodiment of the invention may function to: generate a motion data set for a motion of a user on the basis of at least one image of the motion of the user; determine a partial motion data set for a partial motion of the user by separating the motion data set by partial motions of the user; and determine a first relevance between the partial motion of the user and a reference partial motion by comparing the partial motion data set with a reference partial motion data set determined by separating a reference motion data set by reference partial motions.

The configuration and functions of the motion analysis system 200 according to the invention will be discussed in more detail below.

Next, the device 300 according to one embodiment of the invention is digital equipment capable of connecting to and then communicating with the motion analysis system 200, and any type of digital equipment having a memory means and a microprocessor for computing capabilities, such as a smart phone, a tablet, a smart watch, a smart band, smart glasses, a desktop computer, a notebook computer, a workstation, a personal digital assistant (PDAs), a web pad, and a mobile phone, may be adopted as the device 300 according to the invention.

In particular, the device 300 may include an application (not shown) for assisting a user to be provided with the functions according to the invention from the motion analysis system 200. The application may be downloaded from the motion analysis system 200 or an external application distribution server (not shown). Meanwhile, the characteristics of the application may be generally similar to those of a data set generation unit 210, a data set determination unit 220, a relevance determination unit 230, a motion analysis information generation unit (not shown), a communication unit 240, and a control unit 250 of the motion analysis system 200 to be described below. Here, at least a part of the application may be replaced with a hardware device or a firmware device that may perform a substantially equal or equivalent function, as necessary.

### Configuration of the Motion Analysis System

Hereinafter, the internal configuration of the motion analysis system 200 crucial for implementing the invention and the functions of the respective components thereof will be discussed.

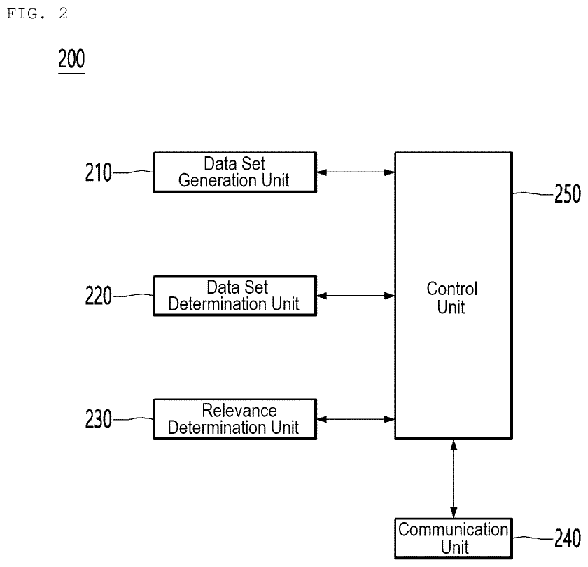

FIG. 2 specifically shows the internal configuration of the motion analysis system 200 according to one embodiment of the invention.

As shown in FIG. 2, the motion analysis system 200 according to one embodiment of the invention may comprise a data set generation unit 210, a data set determination unit 220, a relevance determination unit 230, a communication unit 240, and a control unit 250, and may further comprise a motion analysis information generation unit (not shown) in some cases. According to one embodiment of the invention, at least some of the data set generation unit 210, the data set determination unit 220, the relevance determination unit 230, the motion analysis information generation unit, the communication unit 240, and the control unit 250 may be program modules to communicate with an external system (not shown). The program modules may be included in the motion analysis system 200 in the form of operating systems, application program modules, or other program modules, while they may be physically stored in a variety of commonly known storage devices. Further, the program modules may also be stored in a remote storage device that may communicate with the motion analysis system 200. Meanwhile, such program modules may include, but are not limited to, routines, subroutines, programs, objects, components, data structures, and the like for performing specific tasks or executing specific abstract data types as will be described below in accordance with the invention.

Meanwhile, the above description: is illustrative although the motion analysis system 200 has been described as above, and it will be apparent to those skilled in the art that at least a part of the components or functions of the motion analysis system 200 may be implemented in the device or a server (not shown) or included in an external system (not shown), as necessary.

First, the data set generation unit 210 according to one embodiment of the invention may function to generate a motion data set for a motion of a user on the basis of at least one image of the motion of the user.

Specifically, the user's motion according to one embodiment of the invention may include various motions in taekwondo, taekkyon, wushu, diving, and the like. Further, the image according to one embodiment of the invention may refer to a photographed image in which the user's motion is photographed. Further, the image according to one embodiment of the invention may be acquired from an image sensor. Here, the image sensor according to one embodiment of the invention may be provided in any type of photographing equipment including a mobile device.

For example, the data set generation unit 210 according to one embodiment of the invention may acquire at least one image of the user's motion from at least one image sensor. As another example, the data set generation unit 210 according to one embodiment of the invention may acquire two or more images of the user's motion from two or more image sensors. Here, according to one embodiment of the invention, the two or more image sensors may be disposed at different spatial locations.

Further, according to one embodiment of the invention, in response to the two or more images being acquired from different sensors, reference coordinates respectively applied to the two or more images may be synchronized. That is, the data set generation unit 210 according to one embodiment of the invention may acquire the two or more images from the different sensors, and the reference coordinates respectively applied to the two or more images may be synchronized.

Further, the data set generation unit 210 according to one embodiment of the invention may generate a motion data set for the user's motion.

Specifically, the motion data set according to one embodiment of the invention may include data for separating the user's motion by partial motions or comparing the user's motion with a reference motion.

For example, the motion data set according to one embodiment of the invention may include data obtained by organizing feature point coordinate data, trajectory (e.g., trace) data, rotation data, pattern data, and the like in scalar or vector formats.

As a specific example, the feature point coordinate data according to one embodiment of the invention may include spatial coordinate data of a specific body part (e.g., a joint) of the user extracted from the at least one image.

As another specific example, the trajectory data according to one embodiment of the invention may include spatial trace data of at least one body part of the user extracted from the at least one image.

As another specific example, the rotation data according to one embodiment of the invention may include data such as rotational speed, rotational direction, and rotational time of at least one body part of the user extracted from the at least one image.

As another specific example, the pattern data according to one embodiment of the invention may include pattern data on a trajectory (or feature points) of a body part of the user extracted from the at least one image (e.g., data on the number of repetitions of a specific pattern).

As another example, in response to one image of the user's motion being acquired, the data set generation unit according to one embodiment of the invention may generate a motion data set for the user's motion. Here, the data set generation unit 210 according to one embodiment of the invention may generate a motion data set for a two-dimensional motion on the basis of one image (e.g., two-dimensional image) of the user's motion. Meanwhile, the data set generation unit according to one embodiment of the invention may estimate a three-dimensional motion of the user on the basis of one image (e.g., two-dimensional image) of the user's motion, and generate a motion data set for the three-dimensional motion.

Thus, according to the invention, the motion data set may be generated even when only one image, rather than two or more images, is acquired.

Meanwhile, the motion data set according to one embodiment of the invention may be generated in the form of a time series data set for the user's motion.

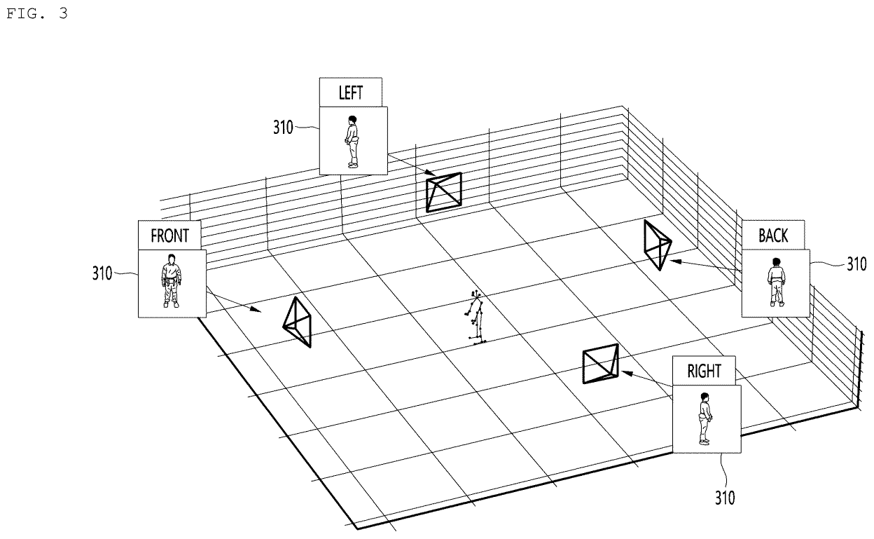

As another example, according to one embodiment of the invention, two or more images may be acquired from two or more different sensors, preferably two or more sensors disposed at different spatial locations, so that motion data included in the motion data set may include motion data for analyzing the user's motion in three dimensions as well as in two dimensions. FIG. 3 illustratively shows a situation in which a motion data set according to one embodiment of the invention is generated.

Referring to FIG. 3, two or more images according to one embodiment of the invention may be acquired from two or more image sensors 310.

For example, referring to FIG. 3, the two or more image sensors 310 may be disposed at different spatial locations, and two or more images may be acquired from the two or more image sensors 310, respectively.

As a specific example, referring to FIG. 3, four image sensors 310 may be disposed at different spatial locations spaced apart from each other, and an image of the user's motion may be acquired from each of the image sensors 310. Here, as the user performs a motion, the user's position may get out of a photographing area of the image sensor (e.g., a field of view of a camera), but a motion data set for the user's motion may be generated when images of the user's motion are acquired from two or more of the four image sensors 310.

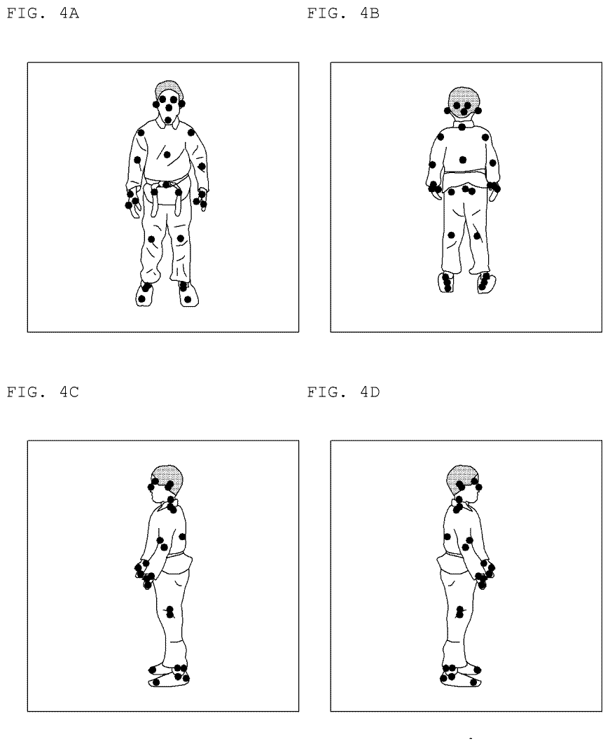

FIGS. 4A to 4D illustratively show a situation in which a motion data set according to one embodiment of the invention is generated.

Referring to FIGS. 4A to 4D, according to one embodiment of the invention, the motion data set may include feature point coordinate data on a specific body part (e.g., a joint) of the user extracted from two or more images of the user's motion. Here, according to one embodiment of the invention, the motion data set may be generated on the basis of one image, but the user's motion may be more precisely analyzed when the motion data set is generated on the basis of two or more images.

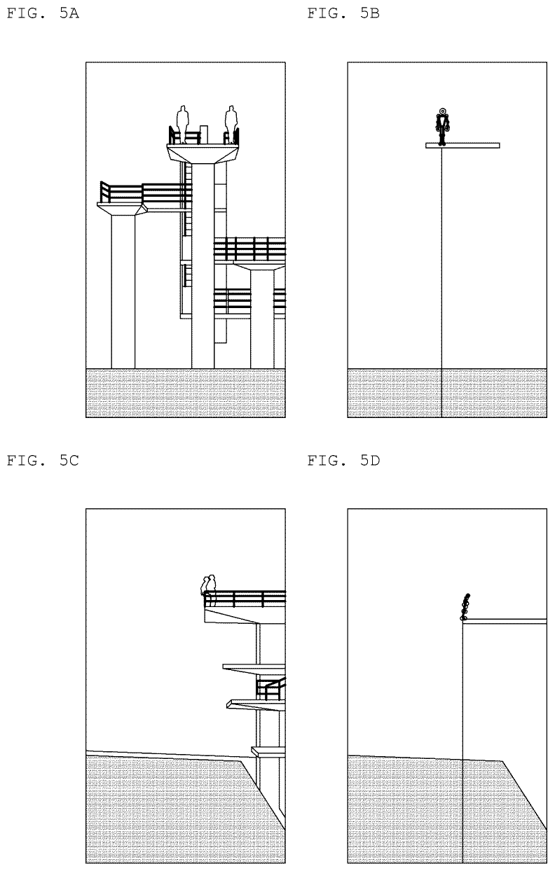

FIGS. 5A to 5D illustratively show a situation in which a motion data set according to one embodiment of the invention is generated.

For example, referring to FIGS. 5A to 5D, according to one embodiment of the invention, two or more images of the user's platform diving motion (i.e., images taken from the front and side of the user) may be acquired, and the user's motion data set may be generated on the basis of the two or more images.

Further, the data set generation unit 210 according to one embodiment of the invention may generate the motion data set using a first motion analysis model that is trained on the basis of preset data on the user's motion.

Specifically, the first motion analysis model according to one embodiment of the invention may include a model that is trained to generate the user's motion data set on the basis of images of the user's motion. Here, the first motion analysis model according to one embodiment of the invention may include, but is not limited to, a machine learning model or an artificial intelligence model.

Further, the data set generation unit 210 according to one embodiment of the invention may generate body part orientation data on the basis of data obtained by organizing feature point coordinate data, trajectory (e.g., trace) data, rotation data, pattern data, and the like in scalar or vector formats.

For example, the body part orientation data according to one embodiment of the invention may include at least one of data on positions of both ends (e.g., a wrist and a middle finger end) of a specific body part (e.g., a left hand), data on a direction from one end to the other end of the body part, and data on an orientation of a specific side of the body part (e.g., data on an orientation of a palm).

According to one embodiment of the invention, in a situation in which the user performs a motion, the user's motion may be differently evaluated when an orientation of a specific side of a body part is changed even if the coordinates of feature points of the body part are the same (e.g., when the user extends the left arm in a ventral direction, the palm may face the ground or face away from the ground). Thus, according to the invention, the data set generation unit 210 may generate body part orientation data that may include data on an orientation of a specific side of a body part, so that the user's motion may be more precisely analyzed.

Next, the data set determination unit 220 according to one embodiment of the invention may function to determine a partial motion data set for a partial motion of the user by separating the motion data set by partial motions of the user. Specifically, the partial motion according to one embodiment of the invention may include a detailed motion constituting the user's motion (e.g., partial motions in platform diving may be separated as a takeoff motion, an aerial motion, and a dive motion, or partial motions in Taegeuk Chapter 1 of taekwondo may be separated as a first low block motion, a middle punch motion, a second low block motion, a low block and middle punch motion, and so on).

For example, the data set determination unit 220 according to one embodiment of the invention may determine the partial motion data set for the user's partial motion by separating the motion data set on the basis of a preset condition (e.g., a condition in which an instantaneous change rate of at least one of the feature point coordinate data, trajectory data, rotation data, and pattern data is not less than a reference value).

As another example, the data set determination unit 220 according to one embodiment of the invention may determine the partial motion data set using a second motion analysis model. Here, the second motion analysis model according to one embodiment of the invention may include a model that is trained to determine the partial motion data set for the user's partial motion by separating the motion data set by partial motions on the basis of preset data on the user's motion. Further, the second motion analysis model according to one embodiment of the invention may include, but is not limited to, a machine learning model or an artificial intelligence model. Furthermore, the second motion analysis model according to one embodiment of the invention may be related to a model that is wholly or partially identical to the first motion analysis model.

As another example, the data set determination unit 220 according to one embodiment of the invention may determine a first partial motion data set for the user's partial motion by separating the motion data set by first partial motions of the user (e.g., a takeoff motion, an aerial motion, and a dive motion in platform diving), and may determine a second partial motion data set for the user's partial motion by further separating the first partial motion by detailed partial motions, i.e., second partial motions (e.g., further separating the aerial motion in platform diving by a first aerial rotational motion, a second aerial rotational motion, and an aerial twisting motion).

As another example, the data set determination unit 220 according to one embodiment of the invention may determine the partial motion data set on the basis of a first relevance to be described below. That is, the partial motion data set may be determined before the first relevance is determined, but may also be determined after the first relevance is determined.

As a specific example, the data set determination unit according to one embodiment of the invention may determine the partial motion data set on the basis of a first relevance between the user's partial motion (e.g., the first aerial rotational motion, the second aerial rotational motion, and the aerial twisting motion) and a reference partial motion (e.g., a reference aerial motion) to be described below (e.g., a sum of the partial motion data sets for the first aerial rotational motion, the second aerial rotational motion, and the aerial twisting motion may be determined as the partial motion data set corresponding to the aerial motion).

Next, the relevance determination unit 230 according to one embodiment of the invention may function to determine a first relevance between the partial motion of the user and a reference partial motion by comparing the partial motion data set with a reference partial motion data set determined by separating a reference motion data set by reference partial motions.

Specifically, the reference motion data set according to one embodiment of the invention may include data that is preset to separate the user's motion by partial motions or compare the user's motion with a reference motion. For example, the reference motion data set according to one embodiment of the invention may include data obtained by organizing feature point coordinate data, trajectory (e.g., trace) data, rotation data, pattern data, and the like in scalar or vector formats. Further, the reference motion data set according to one embodiment of the invention may be included (or stored) in a database included in the motion analysis system 200, an external system, or a reference motion database (not shown). In addition, the reference partial motions according to one embodiment of the invention may be partial motions by which the reference motion is separated to evaluate the user's motion.

Further, the first relevance according to one embodiment of the invention may refer to a relevance between the user's partial motion and the reference partial motion, and may include, but is not limited to, similarity of relative position coordinates of the feature points, similarity of the trajectory data, similarity of the rotation data, similarity of the pattern data, and the like.

For example, according to one embodiment of the invention, the first relevance may be determined to be high when the similarity between the user's partial motion and the reference partial motion is high. Conversely, the first relevance may be determined to be low when the similarity between the user's partial motion and the reference partial motion is low.

As another example, according to one embodiment of the invention, the first relevance may be determined to be high when the similarity between an instantaneous motion at a time-serial comparison point (e.g., a specific point of time) in the user's partial motion and an instantaneous reference motion at the time-serial comparison point in the reference partial motion is high. Conversely, the first relevance may be determined to be low when the similarity between an instantaneous motion at a time-serial comparison point in the user's partial motion and an instantaneous reference motion at the time-serial comparison point in the reference partial motion is low.

Thus, according to the invention, the first relevance may be determined to be high when the similarity between the user's partial motion and the reference partial motion is high, but the first relevance may also be determined to be high when the similarity at a specific time-serial comparison point is high even if the similarity between the user's partial motion and the reference partial motion is low. Further, the user's motion is not evaluated solely based on the similarity, but may be evaluated based on a variety of factors including the characteristics of the motion (e.g., whether the user has taken a specific posture in a particular partial motion).

As another example, the relevance determination unit 230 according to one embodiment of the invention may determine the first relevance by comparing body part orientation data extracted from the partial motion data set with reference body part orientation data extracted from the reference partial motion data set.

Specifically, the relevance determination unit 230 according to one embodiment of the invention may determine the first relevance by comparing the body part orientation data (e.g., data on positions of both ends of a specific body part, data on a direction from one end to the other end of the body part, and data on an orientation of a specific side of the body part) with the reference body part orientation data (e.g., data on reference positions of both ends of the specific body part, data on a reference direction from one end to the other end of the body part, and data on a reference orientation of the specific side of the body part).

For example, according to one embodiment of the invention, it may be assumed that a user performs a partial motion in which the user extends the left hand in a ventral direction with the palm facing the ground, and a reference partial motion is a motion in which the user extends the left hand in a ventral direction with the palm facing away from the ground. Here, the relevance determination unit 230 according to one embodiment of the invention may determine the first relevance by comparing the body part orientation data and the reference body part orientation data (wherein the first relevance may be determined to be low because the similarity between data on positions of both ends of a specific body part and data on reference positions of both ends of the specific body part is high and the similarity between data on a direction from one end to the other end of the body part and data on a reference direction from one end to the other end of the body part is high, while the similarity between data on an orientation of a specific side of the body part and data on a reference orientation of the specific side of the body part is low).

As another example, according to one embodiment of the invention, the reference partial motion associated with the partial motion data set may be determined with reference to the first relevance.

Specifically, the relevance determination unit 230 according to one embodiment of the invention may determine at least one first relevance by comparing the partial motion data set and each of at least one reference partial motion data set. Here, the reference partial motion corresponding to the first relevance that satisfies a preset condition (e.g., the reference partial motion with the highest relevance) among the at least one determined first relevance may be determined to be the reference partial motion associated with the user's partial motion data set.

As a specific example, according to one embodiment of the invention, at least one first relevance may be determined by comparing a partial motion data set for a low block partial motion with each of reference partial motion data sets for a reference low block partial motion, a reference middle punch partial motion, and a reference high block partial motion (e.g., the relevance of the reference low block partial motion may be determined to be 5, the relevance of the reference middle punch partial motion may be determined to be 1, and the relevance of the reference high block partial motion may be determined to be 2). Here, the reference partial motion corresponding to the first relevance that satisfies a preset condition (e.g., the reference low block partial motion, which is the reference partial motion with the highest relevance) among the at least one determined first relevance may be determined as the reference partial motion associated with the user's partial motion data set.

Thus, according to the invention, a specific reference partial motion corresponding to a specific partial motion performed by the user may be determined, so that the user's motion may be evaluated with respect to each partial motion. As another example, the relevance determination unit 230 according to one embodiment of the invention may further determine a second relevance between an overall motion of the user and a reference overall motion by comparing the motion data set and the reference motion data set.

Specifically, the second relevance according to one embodiment of the invention may refer to a relevance between the user's overall motion and the reference overall motion, and may include, but is not limited to, similarity between a time length of the user's overall motion and a time length of the reference overall motion, similarity between an average speed of the user's overall motion and an average speed of the reference overall motion, and various other factors for evaluating the user's overall motion.

Thus, according to the invention, the user's motion may be evaluated in terms of not only the partial motions but also the overall motion, so that the user's motion may be analyzed from diverse perspectives.

Meanwhile, the motion analysis system 200 according to one embodiment of the invention may further comprise a motion analysis information generation unit (not shown).

The motion analysis information generation unit according to one embodiment of the invention may function to generate motion analysis information with reference to at least one of the first relevance and the second relevance.

Specifically, the motion analysis information according to one embodiment of the invention may include at least one of an evaluation score for each of the user's partial motions, an evaluation score for the user's overall motion, and an evaluation score for a sequence in which the partial motions are performed by the user.

For example, according to one embodiment of the invention, the evaluation score for each of the user's partial motions may be determined on the basis of the first relevance, and the evaluation score for the user's overall motion may be determined on the basis of the second relevance.

As another example, according to one embodiment of the invention, a weight may be preset for each of reference partial motions. Here, the motion analysis information generation unit according to one embodiment of the invention may determine the evaluation score for the user's overall motion by applying the corresponding weight to the first relevance for each reference partial motion. Further, according to one embodiment of the invention, a higher weight may be set for a reference partial motion that is determined to be of higher importance, and a lower weight may be set for a reference partial motion that is determined to be of lower importance.

For example, according to one embodiment of the invention, a weight of 1 may be set for a takeoff partial motion, a weight of 10 may be set for an aerial partial motion, and a weight of 1 may be set for a dive partial motion. Here, the motion analysis information generation unit according to one embodiment of the invention may apply the corresponding weights to a first relevance for the user's takeoff partial motion (e.g., 5), a first relevance for the user's aerial partial motion (e.g., 2), and a first relevance for the user's dive partial motion (e.g., 5), respectively, thereby determining an evaluation score for the user's overall motion (e.g., may multiply each of the first relevances by the corresponding weight, thereby determining the evaluation score for the overall motion as 1×5+10×2+1×5=30). Thus, according to the invention, a high weight may be applied to the aerial partial motion, which may be determined to be of the highest importance in platform diving, and the evaluation score for the overall motion may be determined to be low when the first relevance for the aerial partial motion is low even if both the first relevance for the takeoff partial motion and the first relevance for the dive partial motion are high. That is, according to the invention, the user's motion may be reasonably evaluated by applying a higher weight to a partial motion that is determined to be of higher importance.

Next, the communication unit 240 according to one embodiment of the invention may function to enable data transmission/reception from/to the data set generation unit 210, the data set determination unit 220, the relevance determination unit 230, and the motion analysis information generation unit.

Lastly, the control unit 250 according to one embodiment of the invention may function to control data flow among the data set generation unit 210, the data set determination unit 220, the relevance determination unit 230, the motion analysis information generation unit, and the communication unit 240. That is, the control unit 250 according to one embodiment of the invention may control data flow into/out of the motion analysis system 200 or data flow among the respective components of the motion analysis system 200, such that the data set generation unit 210, the data set determination unit 220, the relevance determination unit 230, the motion analysis information generation unit, and the communication unit 240 may carry out their particular functions, respectively.

The embodiments according to the invention as described above may be implemented in the form of program instructions that can be executed by various computer components, and may be stored on a computer-readable recording medium. The computer-readable recording medium may include program instructions, data files, and data structures, separately or in combination. The program instructions stored on the computer-readable recording medium may be specially designed and configured for the present invention, or may also be known and available to those skilled in the computer software field. Examples of the computer-readable recording medium include the following: magnetic media such as hard disks, floppy disks and magnetic tapes; optical media such as compact disk-read only memory (CD-ROM) and digital versatile disks (DVDs); magneto-optical media such as floptical disks; and hardware devices such as read-only memory (ROM), random access memory (RAM) and flash memory, which are specially configured to store and execute program instructions. Examples of the program instructions include not only machine language codes created by a compiler, but also high-level language codes that can be executed by a computer using an interpreter. The above hardware devices may be changed to one or more software modules to perform the processes of the present invention, and vice versa.

Although the present invention has been described above in terms of specific items such as detailed elements as well as the limited embodiments and the drawings, they are only provided to help more general understanding of the invention, and the present invention is not limited to the above embodiments. It will be appreciated by those skilled in the art to which the present invention pertains that various modifications and changes may be made from the above description.

Therefore, the spirit of the present invention shall not be limited to the above-described embodiments, and the entire scope of the appended claims and their equivalents will fall within the scope and spirit of the invention.

What is claimed is:

1. A method for analyzing a user's motion, the method comprising the steps of:
generating a motion data set for a motion of a user on the basis of at least one image of the motion of the user;
determining a partial motion data set for a partial motion of the user by separating the motion data set by partial motions of the user; and
determining a first relevance between the partial motion of the user and a reference partial motion by comparing the partial motion data set with a reference partial motion data set determined by separating a reference motion data set by reference partial motions.

2. The method of claim 1, wherein the at least one image includes two or more images, and the two or more images are acquired from two or more image sensors.

3. The method of claim 1, wherein the at least one image includes two or more images, and
wherein in response to the two or more images being acquired from different sensors, reference coordinates respectively applied to the two or more images are synchronized.

4. The method of claim 1, wherein in the step of determining the first relevance, the first relevance is determined by comparing body part orientation data extracted from the partial motion data set with reference body part orientation data extracted from the reference partial motion data set.

5. The method of claim 1, wherein the reference partial motion associated with the partial motion data set is determined with reference to the first relevance.

6. The method of claim 1, wherein in the step of determining the first relevance, a second relevance between an overall motion of the user and a reference overall motion is further determined by comparing the motion data set and the reference motion data set.

7. The method of claim 6, further comprising the step of:
generating motion analysis information with reference to at least one of the first relevance and the second relevance.

8. The method of claim 7, wherein the motion analysis information includes at least one of an evaluation score for each of the user's partial motions, an evaluation score for the user's overall motion, and an evaluation score for a sequence in which the partial motions are performed by the user.

9. A non-transitory computer-readable recording medium having stored thereon a computer program for executing the method of claim 1.

10. A system for analyzing a user's motion, the system comprising:
a data set generation unit configured to generate a motion data set for a motion of a user on the basis of at least one image of the motion of the user;
a data set determination unit configured to determine a partial motion data set for a partial motion of the user by separating the motion data set by partial motions of the user; and
a relevance determination unit configured to determine a first relevance between the partial motion of the user and a reference partial motion by comparing the partial motion data set with a reference partial motion data set determined by separating a reference motion data set by reference partial motions.

11. The system of claim 10, wherein the at least one image includes two or more images, and the two ore more images are acquired from two or more image sensors.

12. The system of claim 10, wherein the at least one image includes two or more images, and
wherein in response to the two or more images being acquired from different sensors, reference coordinates respectively applied to the two or more images are synchronized.

13. The system of claim 10, wherein the relevance determination unit is configured to determine the first relevance by comparing body part orientation data extracted from the partial motion data set with reference body part orientation data extracted from the reference partial motion data set.

14. The system of claim 10, wherein the reference partial motion associated with the partial motion data set is determined with reference to the first relevance.

15. The system of claim 10, wherein the relevance determination unit is configured to further determine a second relevance between an overall motion of the user and a reference overall motion by comparing the motion data set and the reference motion data set.

16. The system of claim 15, further comprising:
a motion analysis information generation unit configured to generate motion analysis information with reference to at least one of the first relevance and the second relevance.

17. The system of claim 16, wherein the motion analysis information includes at least one of an evaluation score for each of the user's partial motions, an evaluation score for the user's overall motion, and an evaluation score for a sequence in which the partial motions are performed by the user.
